(19) United States
(12) Patent Application Publication
(10) Pub. No.: US 2026/0142715 A1
(43) Pub. Date: May 21, 2026

(54) METHOD OF SATELLITE DATA COLLECTION AND ANALYTIC ESTIMATION OF NTN COVERAGE

(71) Applicant: Google LLC, MOUNTAIN VIEW, CA (US)

(72) Inventor: Ching-Yu LIAO, Mountain View, CA (US)

(21) Appl. No.: 19/100,530

(22) PCT Filed: Aug. 9, 2023
(86) PCT No.: PCT/US2023/029905

§ 371 Date: Jan. 31, 2025

Related U.S. Application Data
(60) Provisional application No. 63/396,597, filed on Aug. 9, 2022.

(51) Int. Cl. H04B 7/185; H04W 16/18

(52) U.S. Cl. CPC H04B 7/18513; H04W 16/18

(57) ABSTRACT

A network entity generates an analytic estimate of an NTN coverage related to a UE based on satellite-related information, UE-related information and UE-related analytics. The network entity may execute a network data analytics function that generates the UE-related analytics. The network entity may acquire the satellite-related information and the UE-related information from various network functions, a base station and/or the UE. The network entity outputs the analytic estimate of the NTN coverage to a user equipment, to a base station or to a network function of the core network.

### FIELD OF THE DISCLOSURE

This document generally describes communication methods related to devices communicating using a non-terrestrial network (NTN) and, more particularly, to techniques for satellite data collection and analytics exposure for NTN coverage.

### BACKGROUND

This background section generally presents the context of the improvement. Work of the presently named inventors, to the extent it is described in this section, as well as aspects of the description that may not otherwise qualify as prior art at the time of filing, are neither expressly nor impliedly admitted as prior art.

A user equipment (UE), which is a device enabling a (mobile) user's access to network services, disconnects from a radio access network (RAN) when outside RAN's coverage. The RAN provides services to UEs located within a cell associated with the RAN. Depending upon its location and subscription, the UE may connect to different networks such as a Home Public Land Mobile Network, HPLMN, (in which the user's profile is held) a Visiting PLMN, VPLMN, (when roaming), etc. Even if located within a RAN cell, a barrier to UE's connectivity may be the Radio Access Technology, RAT, if the UE and the RAN do not use same RAT.

UEs located within terrestrial cells are served by terrestrial network entities without using an NTN. The terrestrial cells are associated with fixed areas, the UEs within such cells being able to continuously connect to the RAN. NTN cells served via a satellite may be associated with different areas at different times due to evolution of satellite's location relative to the Earth surface. Therefore, a UE that can connect to the RAN only via satellite may experience a discontinuous coverage due to a “moving” NTN cell, that is, the UE experiences periods during which it is unable to connect and communicate with the RAN via the satellite. For example, a UE may be able to connect to the RAN via satellite during an in-coverage period lasting 20 minutes every 10 hours. A mobility management entity (MME) may consider NTN coverage when sending commands and configuring UEs (e.g., for mobility management, power saving, etc.) able to connect to the RAN only via satellite (e.g., due to UE's remote location).

UEs may receive ephemeris data related to satellites from the RAN (e.g., ephemeris data may be broadcasted via a system information block such as SIB19 information element, IE, that includes ntn-Config field as described in the 3GPP technical specifications) and/or other satellite assistance information. The UEs can assess satellite coverage (i.e., in coverage and out-of-coverage periods) in an area of interest where the UE is located or is going to be located using such satellite-related information. UEs may implement timers to measure out-ot-coverage periods during an application specific, AS, idle mode.

There is room and need for improving UE, base stations and core network entities awareness of NTN coverage. Broadcasted ephemeris data related to few neighbor cells provides limited scope of NTN coverage. A UE communicating only via a satellite (i.e., a non-terrestrial network, NTN) may temporarily be unable to communicate due to discontinuous NTN coverage. The UE and various network entities may try individually to predict NTN coverage and share their estimates of UE's out-of-coverage period based on satellite ephemeris information and UE's location. However, the individual device's ability to gather information and assess accurately the NTN coverage is limited and attempts to enhance the local estimates may lead to an undesirable volume of overhead.

### SUMMARY

A specialized network entity, NE, generates and outputs an analytic estimate of the NTN coverage related to a user equipment, UE, based on satellite-related information, UE-related information, and UE-related analytics. The NE may execute a network data analytics function (NWDAF) (as defined in 3GPP technical specifications) that generates the UE-related analytics. The analytic estimate of the NTN coverage may include an in-NTN coverage period and/or an out of coverage period for an area of interest, which may be associated with a validity period, a confidence measure, and a list of one or more of subscribers to which the analytic estimate of the NTN coverage is pertinent.

The NE may acquire the satellite-related information from (A) an operations, administration and maintenance function (OAM), (B) a Next Generation Radio Access Network, (NG-RAN) node and/or (C) an application function (AF). The NE may output the estimate of the NTN coverage to a network function such as the Access and Mobility Management Function, (AMF) for delivery to the UE or the NG-RAN node. The outputting of the analytic estimate of the NTN coverage may occur periodically or may be triggered by an event.

### BRIEF DESCRIPTION OF THE DRAWINGS

The accompanying drawings, which are incorporated in and constitute a part of the specification, illustrate one or more embodiments and, together with the description, explain the embodiments.

FIG. 1 is a block diagram of a wireless communication system including a user equipment (UE) and network entities (NEs), configured to generate and use an analytical estimate of non-terrestrial network (NTN) coverage in an area of interest (AOI), according to an embodiment.

FIG. 2 is a schematic representation of communication via a satellite of the UE and NEs in FIG. 1.

FIG. 3 is a diagram illustrating discontinuous NTN coverage for the UE in FIG. 1.

FIG. 4 is an input/output representation of an NE (e.g., a Network Analytics Data Function, NWADF) configured to generate an analytical estimate of NTN coverage in an AOI, according to an embodiment.

FIGS. 5A, 5B and 5C are block diagram illustrating the NE in FIG. 4 collecting satellite data.

FIG. 6 is a signal diagram illustrating an NE (e.g., a NWDAF) subscribing a client (e.g., an Operations, Administration, Maintenance, OAM) to receive the analytical estimate of NTN coverage in an AOI, according to an embodiment.

FIG. 7 is a signal diagram illustrating a first satellite data acquisition scenario, according to an embodiment.

FIG. 8 is a signal diagram illustrating a procedure for collecting satellite-related data from an application function (AF), according to an embodiment.

FIG. 9 is a signal diagram of a procedure for data collection from NFs, according to an embodiment.

FIG. 10 is a signal diagram of a procedure performed by an NE to provide an analytical estimate of NTN coverage in an AOI to a consumer network function (NF), according to an embodiment.

FIG. 11 is a signal diagram of a procedure performed by an NE to provide an analytical estimate of NTN coverage in an AOI to an NG-RAN node, according to an embodiment.

FIG. 12 is a signal diagram of a procedure a procedure performed by an NE to provide an analytical estimate of NTN coverage in an AOI to a UE, according to an embodiment.

FIG. 13 is a flowchart of a method for providing an analytical estimate of NTN coverage, according to an embodiment.

### DESCRIPTION OF EMBODIMENTS

Methods and network entities described in this section perform various techniques for satellite-related data collection and analytic estimation of NTN coverage.

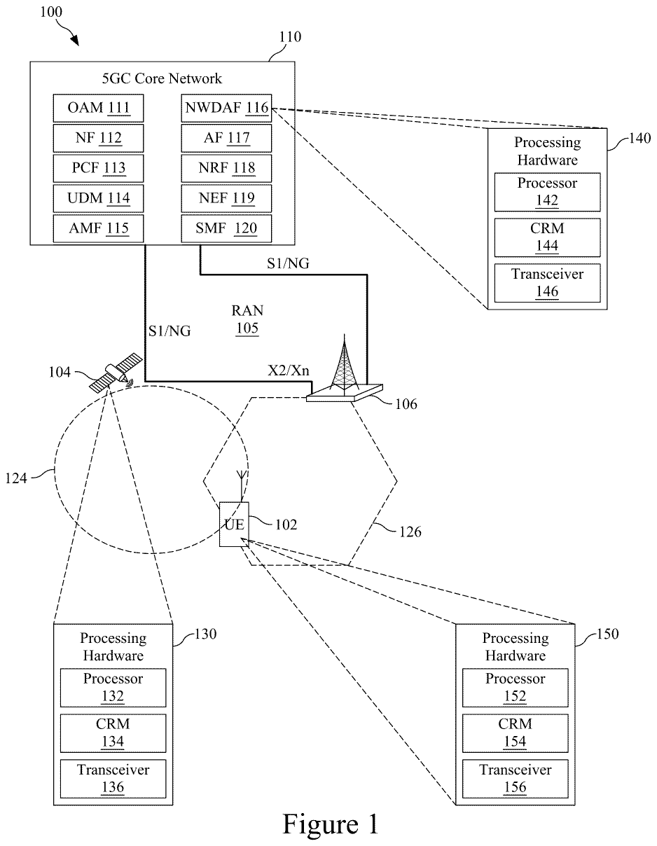

FIG. 1 is a block diagram of a wireless communication system including a UE and NEs configured to generate an analytical estimate of NTN coverage in an area of interest (AOI) according to an embodiment. The wireless communication system 100 includes a UE 102, an NTN base station 104, communicating with UE 102 via satellite, another base station 106, and a core network, CN, 110. The base stations 104 and 106 operate in a Radio Access Network, RAN, 105 connected to the CN 110. In FIG. 1, the CN 110 includes 5G core functions thus being a 5G core (5GC) but it may also be implemented as a sixth generation core, 6GC, or an LTE core.

The NTN base station 104 serves UEs within a cell 124, and the base station 106 serves UEs within a cell 126. If the base station 104 and/or 106 is a gNB, the cell 124 and/or 126, respectively, is a New Radio, NR, cell. If the base station 104 and/or 106 is an ng-eNB or eNB, the cell 124 and/or 126 is an evolved universal terrestrial radio access, E-UTRA, cell. The cells 124 and 126 may be in the same Radio Access Network Notification Area, RNA, or different RNAs. In general, the RAN 105 includes any number of base stations, and each of the base stations covers (i.e., serve UEs within) one, two, three, or any other suitable number of cells. The UE 102 supports at least one of a 5G NR (or simply, “NR”) or E-UTRA air interface to communicate with one or both base stations 104 and 106. Each of the base stations 104, 106 connects to the 5GC 110 via an interface (e.g., S1 or NG interface). The base stations may also be interconnected via an interface (e.g., an X2 or an Xn interface for interconnecting NG RAN nodes).

The 5G CN 110 may be hosted by one or more physical devices that may be collocated. In this document, base stations and physical devices hosting core network functions/modules may be called network entities (NEs) but more generally, the term “network entity” stands for a RAN device with a well-defined network functionality (e.g., base station functionality is connecting UEs to the core network including managing communications to and from the UEs). Among other components, the 5GC 110 includes an Operations, Administration and Maintenance (OAM) 111, a network function (NF) 112, a Policy Control Function (PCF) 113, a Unified Data Management (UDM) 114, an Access and Mobility Management Function (AMF) 115, a Network Data Analytics Function (NWDAF) 116, an Application Function (AF) 117, a Network Repository Function (NRF) 118, a Network Exposure Function (NEF) 119, and a Session Management Function (SMF) 120. The OAM 111 intermediates and manages one or more NEs. The NF 112 stands for core network functions not explicitly specified. The PCF 113 is a function providing policy rules to control plane functions. The UDM 114 performs subscription management. The AMF 164 is configured to manage UE authentication, registration, paging, and other similar functions. The NWDAF 116 is configured as an analytics function on various types of data. The AF 117 is configured to influence application traffic routing. The NRF 118 is configured to allow NFs to register for network services. The NEF 119 is configured to provide secure and robust access to exposed portions of a network and the SMF 120 is configured to manage Packet Data Unit, PDU, sessions.

As illustrated in FIG. 1, the base station 104 supports (i.e., covers, serves UEs within) the cell 124, and the base station 106 supports a cell 126. The cells 124 and 126 may partially overlap, so that the UE 102 selects, reselects, or is handed over from one of the cells 124 and 126 to the other. To directly exchange messages or information, the base station 104 and the base station 106 support an X2 or Xn interface. In general, the 5GC core network 110 connects to any suitable number of base stations supporting NR cells and/or EUTRA cells, using, for example, an S1 or an NG interface.

As discussed in detail below, the UE 102 and/or NEs of the RAN 105 (e.g., BSs 104 and/or 106) may utilize the techniques described in this section for enhancing NWDAF analytics in support of estimating NTN out of coverage events and NTN in coverage events for the UE 102.

The base station 104 is equipped with processing hardware 130 that includes one or more general-purpose processors (e.g., CPUs) 132 and a non-transitory computer-readable medium (CRM) 134 storing instructions that the one or more general-purpose processors execute. Additionally or alternatively, the processing hardware 130 may include special-purpose processing units. The processor 132 is configured to process data that the base station 104 receives in the uplink direction or transmits in the downlink direction according to various techniques described in this section. The processing hardware 130 also includes a transceiver 136 (term that here stands also for antenna(s) and radio-frequency front-end electronics that are not illustrated separately in this figure) configured to transmit the data in the downlink direction and to receive data in the uplink direction. The base station 106 includes generally similar components. In particular, components 140, 142, 144, and 146 of the base station 106 are similar to the components 130, 132, 134, and 136, respectively.

The UE 102 is equipped with processing hardware 150 that includes one or more general-purpose processors 152 such as CPUs and non-transitory computer-readable memory 154 storing machine-readable instructions executable on the one or more general-purpose processors, and/or special-purpose processing units. The processor 152 is configured to process data that the UE 102 transmits in the uplink direction and/or receives in the downlink direction. The processing hardware 150 may also include a transceiver 156 (term that here stands also for antenna(s) and radio-frequency front-end electronics that are not illustrated separately in this figure) configured to transmit and receive data.

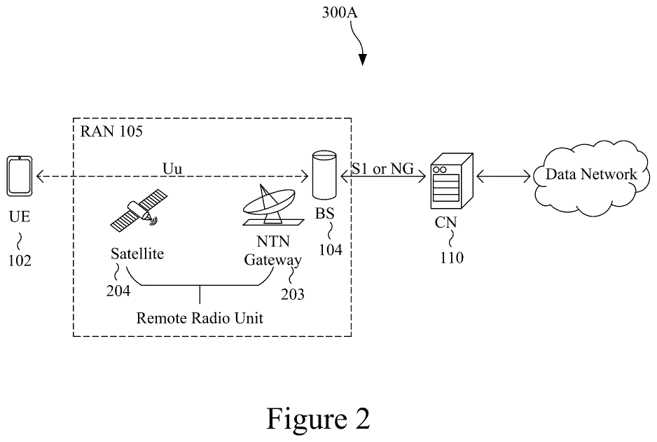

FIG. 2 illustrates a certain type of NTN deployment referred to as transparent payload architecture, which involves a satellite gateway (also known as an NTN Gateway) 203 and a “transparent” satellite 204 for extending the range of the Uu interface. The satellite 204 implements a frequency conversion and a Radio Frequency, RF, amplifier in both the uplink and downlink directions. The satellite function is similar to that of an analog RF repeater. As a result, the satellite 204 repeats the Uu radio interface from the feeder link (between the NTN gateway and the satellite) to the service link (between the satellite and the UE) in the downlink direction and vice versa in the uplink direction. The Satellite Radio Interface, SRI, on the feeder link is the Uu, and the NTN gateway 203 supports all necessary functions to forward the signal of the Uu interface. The NTN gateway 203 may be placed at the same location as the base station (e.g., eNB or gNB) 104, or may be connected to the base station 104 via a wired link. It is also possible to connect more than one NTN gateway to a base station. Different transparent satellites may be connected to the same base station on the ground, via the same NTN gateway, or via different NTN gateways.

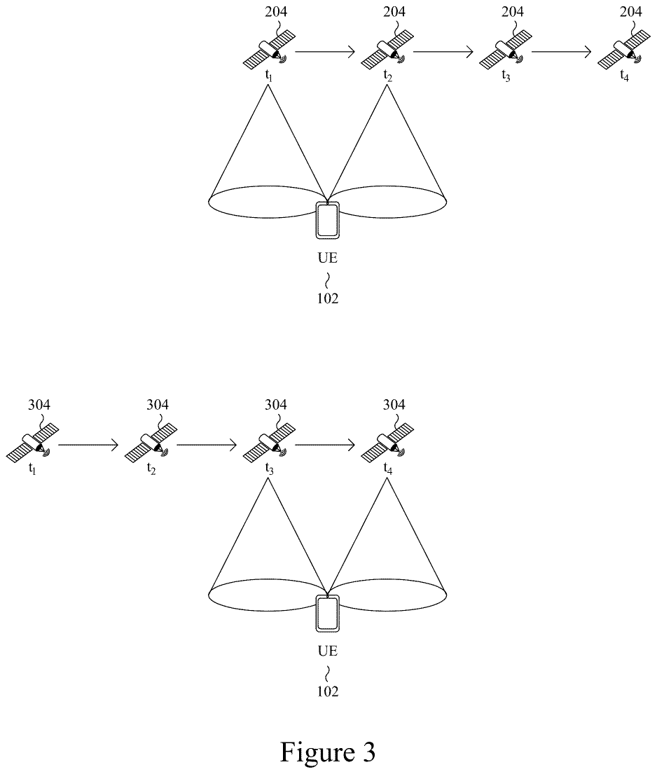

FIG. 3 is a diagram illustrating discontinuous NTN coverage for a UE. The UE 102 is stationary and located in the concerned geographical area experiences discontinuous coverage. As illustrated in the upper part of FIG. 3, the UE 102 is in a cell served by a low earth orbit, LEO, satellite 204 from t1 to t2, and then, as illustrated in the lower part of FIG. 3, the UE 102 served by another LEO satellite 304 from t3 to t4. In the period between t2 to t3, the UE 102 is not served by any satellite or any terrestrial base station and therefore is disconnected from the RAN. When losing its connection a serving cell, the UE may start seeking other cells to connect. However, in the example illustrated in FIG. 3, the UE 102 cannot find a cell between t2 to t3 which may last minutes or hours hours. The cell search causes extra, unnecessary power consumption in the UE 102.

To avoid additional power consumption, the UE 102 may be configured not to perform the cell search and deactivate its Access Stratum, AS, functions for the period when the UE is not within the area of coverage of a satellite. In some implementations, the UE has information about how long (i.e., the out-of-coverage period) and in which area (AOI) the UE has no NTN coverage and can, therefore, re-activate its cell search or AS functions when an in-NTN coverage begins.

In terms of the satellite moving pattern, there are three types of service links that are supported in NTN: (1) Earth-fixed for satellites that provide beam(s) continuously covering the same geographical areas (e.g., GEO/GSO satellites); (2) Quasi-Earth-fixed for satellites that provide beam(s) covering one geographic area for a limited period and a different geographic area during another period (e.g., low earth orbit/medium earth orbit, LEO/MEO, satellites capable of using steerable beams); and (3) Earth-moving for satellites that provide beam(s) whose coverage area slides over the Earth surface (e.g., LEO/MEO satellites using fixed or non-steerable beams).

Thus, an eNB connected via NTN may provide either quasi-Earth-fixed cell coverage or Earth-moving cell coverage using LEO/MEO satellites. The eNB provides Earth fixed cell coverage using GEO satellites.

The interaction between network functions, NFs, may be represented in two ways. For example, firstly a service-based representation, where network functions enable other authorized network functions to access their services (this representation also includes point-to-point reference points where necessary); and secondly a reference point representation, which shows that interactions exist between network functions where a reference point is depicted between those network functions.

The NWDAF as currently defined (e.g., in 3GPP TS 23.288) collects UE mobility related information from NFs and OAM to perform data analytics yielding UE mobility statistics or predictions. Various embodiments described in this section enhance conventional NWDAF and other nodes/NFs by generating improved estimates (predictions) of NTN coverage by enlarging quantity and quality of input data used to generate an analytic estimate of the NTN coverage. Providing the analytic estimate of the NTN coverage to the UE 102, NG-RAN 104 and/or 5G CN 110 enable mobility management enhancement and more efficient power saving scheduling. Various embodiments also illustrate techniques employed for providing the analytic estimate of NTN coverage to service consumers (e.g., UE/NG-RAN/AMF) for assisting the decision of the power saving mechanism(s) to stay at the current PLMN/Satellite RAT and out of NTN coverage.

The following embodiment descriptions use one or more of the following assumptions: (1) the NTN is a non-GEO (non-geostationary satellite) network, the satellites motion causing the NTN cell(s) to temporarily covers different portions of areas. Embodiments may use data collection architecture from any 5GC NF and Network Data Analytics Exposure architecture, and embodiments may also be applied to Data Collection architecture and Analytics Exposure architecture using Data Collection Coordination as described in 3GPP technical specification (e.g., 3GPP TS 23.288).

Embodiments OAM mechanisms deployed in 5G networks with an interface (e.g., a proprietary interface) between the NWDAF 116 and OAM 111. The OAM has management functionalities for producing/consuming services for satellite data to/from 5G CN 110 and NG-RAN 104. OAM provides the required mechanisms to guarantee the continuous data collection requested by NWDAF. Although the OAM functions and mechanisms are not described in detail in this document, they are described in 3GPP technical specifications and otherwise well known.

Another assumption is that the UE 102 has the capability to determine its location (e.g. by global navigation satellite system, GNSS, or by positioning procedures at the UE as indicated in 3GPP technical specifications) and has user consent to provide its location to the NG-RAN/5G CN/AF. For NG-RAN awareness of UE location, it is assumed the NG-RAN 104 can get the estimate of UE location information from 5G CN 110 or from the UE 102. For AMF 115 awareness of UE location, it is assumed the AMF 115 can get the estimate of UE location information from other NFs 112 in the 5G CN 110 or from UE 102 or NG-RAN node 104.

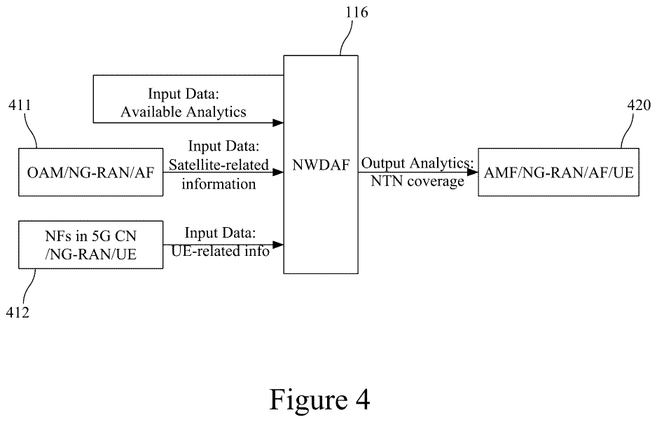

FIG. 4 is an input/output representation of an NE (e.g., NWDAF) configured to generate an analytical estimate of NTN coverage in an AOI, according to an embodiment. The NWDAF 116 uses an analytics model for predicting, estimating and/or generating an analytic estimate of the NTN coverage. Input data may include one or more of the following pieces of information: (1) satellite-related data (e.g., Ephemeris data, of one or more satellites, from OAM 111, NG-RAN 104, or AF 117); (2) available UE-related analytics (e.g., expected UE behavioral parameters that may include one or both of the analytics of UE mobility and UE communication) and (3) UE-related information acquired, for example, using Event Exposure from 5GC NFs 112, NG-RAN 104 (via AMF 115), or UE 102 (via AMF 115 or AF 117).

In an embodiment, output analytics of NTN coverage may include: (1) Analytics ID: NTN Coverage; and (2) NTN coverage Type which includes Ephemeris data, estimate of in NTN coverage period, and/or estimate of out of NTN coverage period.

In another embodiment, different analytics IDs may be applied, for example, Analytics ID: the NTN Coverage of Emperies data, and/or Analytics ID: the NTN Coverage of Estimate of in NTN coverage period, Estimate of out of NTN coverage period.

As illustrated in FIG. 4, the NWDAF 116 receives the available analytics as input data, in addition to satellite-related information input data acquired from the OAM/NG-RAN/AF 411 and/or UE-related information acquired from the NFs in a 5G CN/NG-RAN/UE 412. The NWDAF 116 outputs the analytic estimate of the NTN coverage to one or more of the AMF/NG RAN/AF/UE 420.

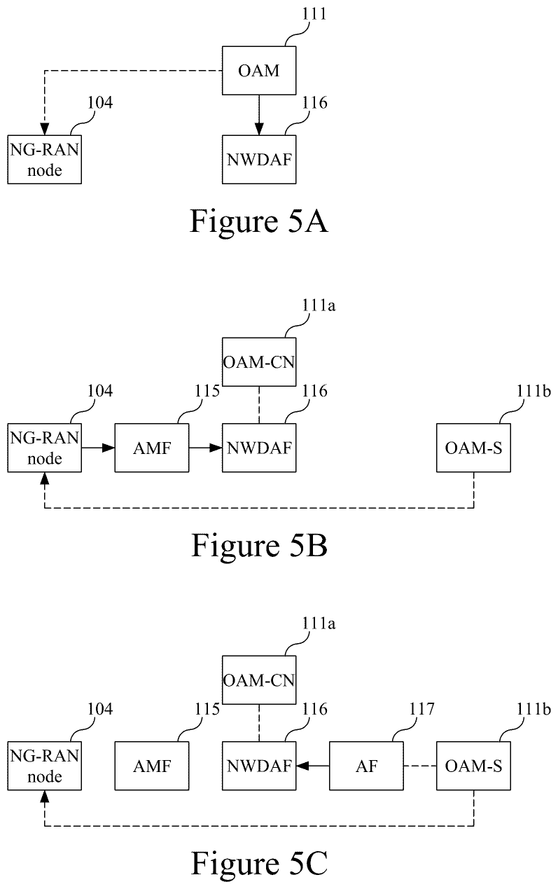

FIGS. 5A, 5B and 5C are block diagrams illustrating the NWDAF 116 collecting satellite data in different deployments scenarios. In FIG. 5A, the OAM 111 provides satellite-related information directly to the NWDAF 116. The OAM 111 may provide the same information to NG-RAN node 104.

In FIG. 5B, a first OAM (OAM-CN 111a) manages NFs in the RAN serving the UE but the satellites enabling the UE to connect to the RAN pertain to another network with another second OAM (OAM-S 111b). The second OAM (OAM-S 111b) may provide satellite-related information to NG-RAN node(s) 104. The NWDAF 116 collects satellite-related information from the NG-RAN node(s) 104 via the AMF 115.

In FIG. 5C, similar to the scenario illustrated in FIG. 5B, the OAM-CN 111a manages NFs in the RAN serving the UE but the satellites enabling the UE to connect to the RAN pertain to another network being managed by the OAM-S 111b. In this scenario, the NWDAF 116 collects satellite-related information from the OAM-S 111b via the AF 117. The OAM-S 111b may provide satellite-related information also to NG-RAN node(s) 104.

In order to acquire more accurate satellite-related information as exemplarily illustrated in FIGS. 5A-5C, the NWDAF 116 has to subscribe to services of OAMs, NG-RAN via AMF, and AF. For this purpose, in one embodiment, features of Event Exposure functionalities between AMF/AF and NWDAF are enhanced to enable the Event ID to specify “Satellite Data” and Event Filter parameters related to the Satellite Data.

The Event Filter parameters that correspond to Event ID Satellite Data may include: (A) ephemeris information (provided on a regular basis or upon demand) that describes the orbital trajectory information or coordinates for the NTN vehicles information; (B) an ephemeris format Type such as a position Velocity type (e.g., Satellite position and velocity state vectors: Position, Velocity) and an orbital type (e.g., Semi-major axis; Eccentricity; Argument of periapsis; Longitude of ascending node; Inclination; and Mean anomaly at epoch time provided in orbital parameter ephemeris format); (C) an explicit epoch time: associated to ephemeris data; (D) Area of Interest (AOI) information (which may refer to predefined areas that are represented by a list of Tracking Areas, list of cells or list of (R)AN node identifiers, and for Naf_EventExposure related service operation, the AOI may be translated by NEF to geographic areas, and vice versa); and (E) location(s) of the NTN-Gateways (usable for the Uplink timing, frequency synchronization and possible also for the random access and the mobility management purposes). The Event Filter parameters may further include additional information, such as, information to enable NG-RAN node operation. For example, for feeder/service link switch overs, the information sent to NG-RAN node may depend on the type of supported service links (e.g. earth fixed beams, quasi earth fixed beams, earth moving beams, etc.).

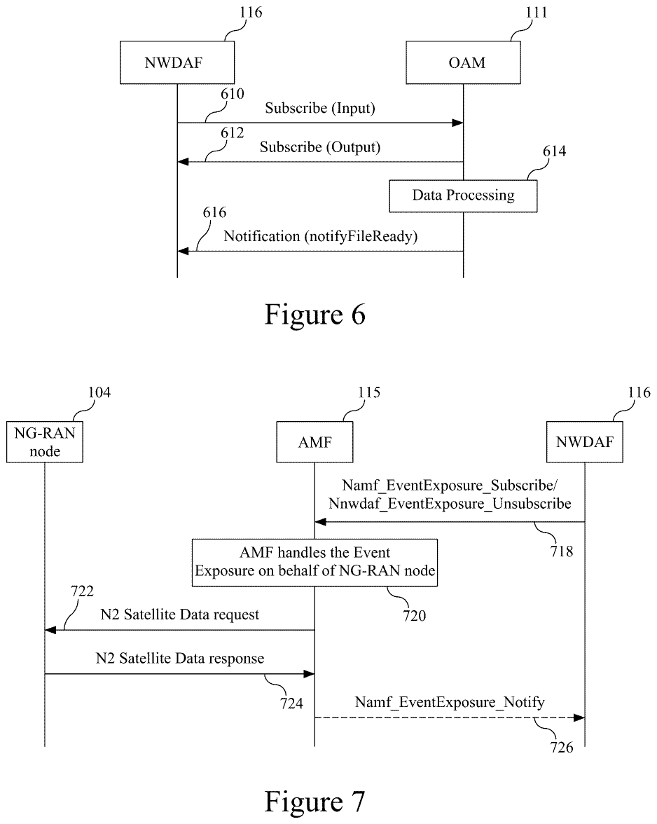

FIG. 6 is a signal diagram illustrating a procedure for NWDAF 116 to subscribe for receiving, from OAM 111, management data that are relevant generating an analytic estimate of the NTN coverage. The NWDAF 116 initiates 610 this procedure by indicating (the input) the following information: (1) Data type: Satellite Data; (2) Subscription type: one time or on a regular basis based on periodicity or duration, etc. ; (3) Validity Conditions: time, accuracy, confidence level, resolution, etc. ; and (4) Input Filter: a number of parameters may be provided as requirements of the Satellite Data. Further, the Input may specify parameters for an Input filter including: (1) Ephemeris information (describing the orbital trajectory information or coordinates for the NTN vehicles, provided on a regular basis or upon demand); (2) an Ephemeris format Type (e.g., position Velocity type and orbital type as described above for ephemeris data); (3) an explicit epoch time associated to ephemeris data; and (4) AOI information, which may be geographic areas or refer to predefined areas that are represented by a list of Tracking Areas, list of cells or list of (R)AN node identifiers.

The OAM 111 responds to the NWDAF 116 with a subscribe request result as Subscribe (Output) 612. The OAM 111 performs data processing 614 to process the required data. Then, when the requested data is ready, the OAM 111 notifies (notifyFileReady) 618 the NWDAF 116. As the final step (not shown), the NWDAF 116 fetches data by using, for example, file transfer protocol, FTP.

In an embodiment, the NWDAF subscribes to NG-RAN via AMF for acquiring Satellite Data as illustrated in FIG. 5B. The AMF described in the 3GPP technical specifications is modified to provide delegation functionalities for NG-RAN 104 because NG-RAN node 104 is not (at least in this embodiment) a NF in a 5G CN 110. AMF services used by NWDAF 116 for data collection invoke a Namf_EventExposure procedure similar to the one as described in 3GPP technical specifications (e.g., in 3GPP TS 23.502).

The AMF 115 may identify its role of delegation for NG-RAN based on a new Event ID associated for NG-RAN. When the AMF 115 receives the Event Exposure request from NWDAF 116, the AMF 115 may: (1) identify the target NG-RAN node based on the target UE identifier or NG-RAN node ID indicated by the NWDAF 116 in the Namf_EventExposure_Subscribe message; and (2) if the event exposure requires the information from NG-RAN (e.g., a New Event ID for satellite Data) the AMF 115 activates the delegation functionalities to initiate N2 procedure for retrieving the information from the NG-RAN node. The NG-RAN 104 sets up the mechanisms to guarantee the continuous data collection requested by NWDAF via AMF using UE-associated or non-UE associated NGAP message. UE-associated NGAP message is used when the Target of Event Reporting indicates Target UE ID(s). Non-UE associated NGAP message is used when the Target of Event Reporting indicates Any UE.

FIG. 7 is a signal diagram illustrating a first satellite data acquisition scenario, according to an embodiment. The NWDAF 116 subscribes to AMF 115 services by sending a Namf_EventExposure_Subscribe message 718. The Namf_EventExposure_Subscribe message 718 may include the following information: (1) Event ID for Satellite Data; (2) Event Filter(s) as previously described (i.e., Ephemeris information, Ephemeris format Type, explicit epoch time associated to ephemeris data, AOI); (3) Target of Event Reporting (that indicates Target UE(s) ID(s), which may be UE ID(s) including a General Public Subscription Identifier, GPSI, a Subscription Permanent Identifier, SUPI, a UE IPv4 address(es), a UE IPv6 prefix(es), an Internal/External Group Identifier, or an indication that any UE is targeted); (4) a Notification Target Address; (5) Event Reporting Information, (e.g., Event reporting mode, maximum number of reports, periodic reporting along with periodicity, etc., as defined for example in 3GPP TS 23.502 Table 4.15.1-1) and (6) an expiry time for the subscription.

The AMF provides delegation services to the NG-RAN for the event exposure requested by the NWDAF in the following steps: (1) the AMF handles the event exposure 720 for the NG-RAN node. If the required information is available, the AMF 115 and NG-RAN node 104 do not transmit/receive messages 722 and 724, instead responding to the NWDAF 116 by sending the required information in Namf_EventExposure_Notify message 726.

If the required information is not available, the AMF 115 AMF sends a new-Generation Application Protocol, NGAP, message 722 (e.g., N2 Satellite Data request) to a target NG-RAN node 104. This message based on NWDAF 116 request may include the following information based on NWDAF 116 request: (1) Event ID for Satellite Data (optional, this is included if the N2 UE-associated NGAP message or non-UE-associated NGAP message is not used specifically for Satellite Data), (2) Event Filter(s) as previously described (e.g., Ephemeris information, Ephemeris format Type, explicit epoch time associated to ephemeris data, AOI, etc.), and (3) Target of Event Reporting (that indicates Target UE ID(s) (as previously described).

The NG-RAN node 104 then processes the request to provide the required data to the AMF 115 as a result of the subscribe request. The NG-RAN node 104 provides the information to the AMF 115 using a UE-associated NGAP message 722 or non-UE associated message, (e.g., an N2 Satellite Data response). The message may include an Event ID (optional, this is included if the N2 UE-associated NGAP message or non-UE-associated NGAP message is not used specifically for Satellite Data), the Target UE ID(s) (either external UE ID(s), or Internal/External Group Identifier, or UE IP v4 address(es) or UE IP v6 prefix(es), Satellite Data corresponding to the settings indicated in Event Filters (AOI is translated by NEF before transmitting message 726), and a time stamp. This process may be completed when the AMF 115 responds to the NWDAF 116 in Namf_EventExposure_Notify 726 message including available information or the information received from the NG-RAN node 104.

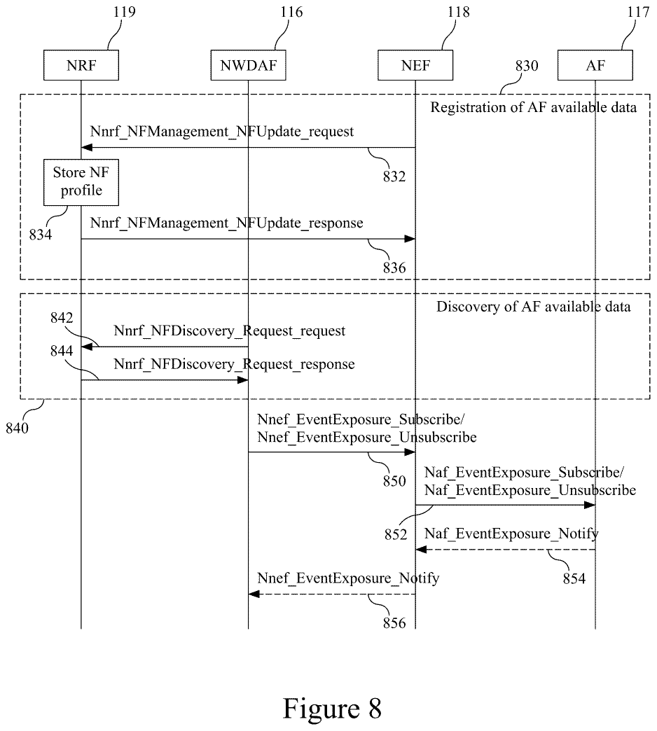

FIG. 8 is a signal diagram illustrating a procedure for collecting satellite-related data from an application function (AF), according to an embodiment. This procedure enables receiving third party data and operates as schematically illustrated in FIG. 5C. This procedure is similar to a procedure for an NWDAF to obtain AF services using a Naf_EventExposure type of service operation described in 3GPP technical specifications (e.g., 3GPP TS 23.502).

The conventional AF 117 is enhanced to handle a new Event ID for Satellite Data. An initial phase achieves Registration of AF available data 830. The NEF 118 sends an Nnrf_NFManagement_NFUpdate_request message 832 to the NRF 119, which then stores 834 the NF profile. The NRF 119 sends an Nnrf_NFManagement_NFUPdate_response message 836 to the NEF 118. In order to discover 840 satellite-related data the AF is able to provide, the NWDAF 116 transmits an Nnrf_NFDiscovery_Request_request 842 to the NRF 119, which in turn transmits an Nnrf_NFDiscovery_Request_response 844 to the NWDAF 116. This response indicates the satellite-related data the AF is able to provide.

The NWDAF 116 the transmits an Nnef_EventExposure_Subscribe (or Nnef_EventExposure_Unsubscribe) message 850 to the NEF that in turn transmits a Naf_EventExposure_Subscribe (or Naf_EventExposure_Unsubscribe) message 852 to the AF 117. The Nnef_EventExposure_Subscribe message 850 and Naf_EventExposure_Subscribe messages 852 may include the following information: (1) Event ID for Satellite Data; (2) Event Filter(s) as previously described (e.g., Ephemeris information, Ephemeris format Type, explicit epoch time associated to ephemeris data, AOI which may be translated by the NEF before transmitting message 852, etc.) (3) Target of Event Reporting that indicates Target UE ID(s), which may be either UE ID(s) including GPSI or SUPI, or a UE IPv4 address(es), or a UE IPv6 prefix(es), or an Internal/External Group Identifier, or an indication that any UE is targeted; (4) Notification Target Address; (5) Event Reporting Information, e.g., Event reporting mode, maximum number of reports, periodic reporting along with periodicity, etc., as defined 3GPP technical specifications (for example, 3GPP TS 23.502) and (6) an expiry time for the subscription.

Optionally, AF 117 may then transmit a Nnef_EventExposure_Notify message 854 to the NEF 118, and the NEF 118 may then transmit a Naf_EventExposure_Notify message 856 to the NWDAF 116. These Notify messages may include the following information: (1) Event ID; (2) a target UE ID(s) (either external UE ID(s), or an Internal/External Group Identifier, or a UE IP v4 address(es) or a UE IP v6 prefix(es)); (3) satellite data corresponding to the settings indicated in Event Filters (AOI is translated by NEF 118 transmission of message 856); and (4) a time stamp.

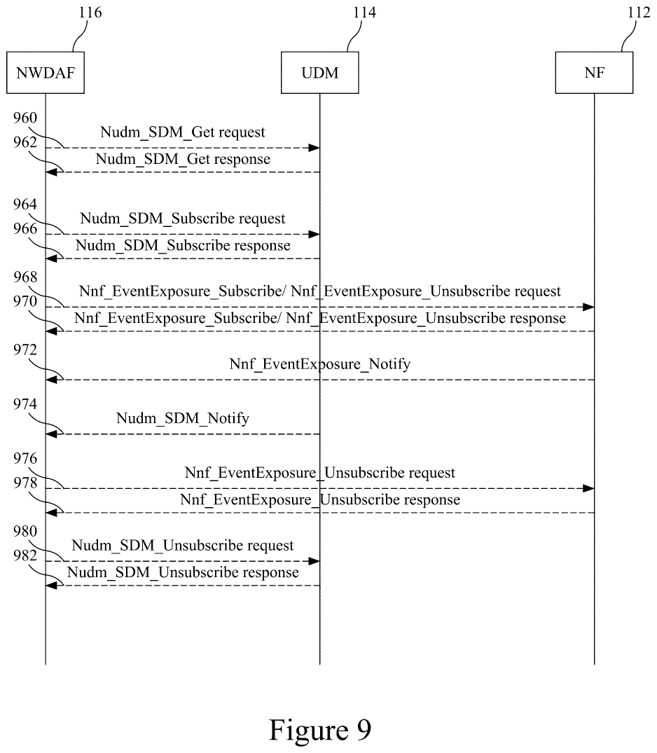

The NWDAF 116 may collect UE-related information from 5GC NFs for NTN coverage analytics using procedures described in 3GPP technical specification (e.g., 3GPP TS 23.288). FIG. 9 is a signal diagram of a procedure for data collection from NFs.

The NWDAF 116 first transmits a Nudm_SDM_Get request message 960 to the UDM 114. The UDM 114 replies with an Nudm_SDM_Get response message 962. The NWDAF 116 then transmits an Nudm_SDM_Subscribe request message 964 to the UDM 114 that responds with an Nudm_SDM_Subscribe response message 966. Further, the NWDAF 116 transmits an Nnf_EventExposure_Subscribe (or Unsubscribe) request message 968 to the NF 112. The NF 112 responds with an Nnf_EventExposure_Subscribe (or Unsubscribe) response message 970. The NWADF 116 may later transmit an Nnf_EventExposure_Notify message 972 to the NF 112. The UDM 114 may transmit an Nudm_SDM_Notify message 974 to the NWDAF 116. The NWDAF 116 then transmits an Nnf_EventExposure_Unsubscribe request message 976 to the NF 112. The NF 112 responds with an Nnf_EventExposure_Unsubscribe response message 978. The NWDAF 116 transmits an Nudm_SDM_Unsubscribe request message 980 to the UDM 114 that responds with an Nudm_SDM_Unsubscribe response message 982.

UE-related data collection from AF via NEF may use the same procedure as illustrated in FIG. 8. UE access and mobility information event, Event ID is defined in 3GPP TS 23.502 clause 4.15.1 and Table 4.15.3.1-1. If collecting data from AMF, the AMF service operation of Namf_EventExposure is defined in 3GPP TS 23.502 clause 5.2.2.3, whereby the event ID and the Event Filters are used to specify the list of conditions/parameters to match for notifying the event identified by the event ID.

The following UE 102 access and mobility information events may be applicable for estimation/prediction of NTN coverage (Event ID is defined in 3GPP technical specification): (A) Location Report (TAI, Cell ID); (B) UE moving in or out of a subscribed AOI, as described in 3GPP technical specifications; (C) number of UEs served by the AMF and located in AOI; (D) registration state changes (e.g., registered or deregistered); (E) connectivity state changes (e.g., IDLE or CONNECTED); (F) UE loss of communication; UE reachability status; (G) frequent mobility re-registration; (H) UE access behavior trends per 3GPP technical specifications (see, e.g., 3GPP TS 23.502 clause 4.15.4.2); and (I) UE location trends per 3GPP technical specifications (see e.g., 3GPP TS 23.502 clause 4.15.4.2).

The parameters for an AMF exposure event for a UE using Satellite RAT may be enhanced to support RAN node and cell level. For example, Event ID: Location Report may include an Event Filter: <Parameter Type=Location Filter, Value=TA1>. In another example, Event ID: Access Type may include an Event Filter which includes one or more of the following: <Parameter Type=AN Type, Value=3GPP Access“>; and <Parameter Type=3GPP Access Type, Value=Satellite Access”>.

In yet another example, Event ID: UE moving in or out of Area of Interest; and Event Filter may include one or more of the following (RAN Node ID, Cell ID may refer to, for example, 3GPP TS 38.413): <Parameter Type=TAI, Value=TA 2>; <Parameter Type=Global RAN Node ID or RAN node ID (without PLMN ID), Value=Global gNB ID #X>; and <Parameter Type=Global Cell-ID or Cell ID (without PLMN ID), Value=Cell-ID #X>.

Additionally, for Event ID: Location, Event Filter may include one or more of the following: <Parameter Type=TAI, Value=wildcard> (to report any TAI change); <Parameter Type=Global RAN Node ID, Value=wildcard> (to report any RAN node change); and <Parameter Type=Global Cell-ID or Cell ID (without PLMN ID), Value=wildcard> (to report any Cell-ID change).

In order to support data collection for non-satellite data from an NG-RAN node, the AMF 115 is enhanced with delegation functionalities for NG-RAN 104 because the NG-RAN node 104 is not a NF in the 5G CN 110.

In order to enable the AMF 115 to identify its role of delegation for NG-RAN a new Event IDs associated with NG-RAN may be provided or an existing event ID with parameters related to NG-RAN level information may be indicated in Event Filter.

When the AMF 115 receives 718 the Event Exposure request from NWDAF 116, the AMF 115 may identify the target NG-RAN node(s) based on the target UE identifier or NG-RAN node ID(s) indicated by the NWDAF in the Namf_EventExposure_Subscribe message 718. If the event exposure 720 requires the (satellite-related or UE-related) information from a NG-RAN node 104, the AMF 115 activates the delegation functionalities to initiate N2 procedure for retrieving the information from the NG-RAN node, stores the Event ID and the one or more target RAN node ID(s) with the related the EventExposure information and sets the event triggers for the Event ID and initiate N2 procedure if the required information is not available.

Returning to FIG. 7, initially, the NWDAF 116 subscribes to AMF 115 services which activates the AMF delegation function to handle the event exposure by the NG-RAN node 104. Therefore, the Namf_EventExposure_Subscribe message 718 includes one or more Event ID(s) and the following information for each Event ID (which may be a new Event ID for NG-RAN or an existing Event IDs defined in 3GPP technical specification, for example, 3GPP TS 23.502): an Event Filter, the Target of Event Reporting indicates Target UE ID(s) (which may be either UE ID(s) including GPSI or SUPI, or a UE IPv4 address(es), or a UE IPv6 prefix(es), or an Internal/External Group Identifier, or indication that any UE is targeted), a Notification Target Address, Event Reporting Information (e.g., event reporting mode, maximum number of reports, periodic reporting along with periodicity, etc., as defined in 3GPP technical specifications, for example 3GPP TS 23.502 Table 4.15.1-1) and an expiry time for the subscription.

The AMF 115 provides delegation services to the NWDAF 116. In providing the delegation service, the AMF 115 handles the event exposure 720 for the NG-RAN node. If the required information is available, messages 722 and 724 are not transmitted/received and instead the AMF 115 responds to the NWDAF 116 by transmitting Namf_EventExposure_Notify message 726. Otherwise, the AMF 115 transmits message 722.

The AMF initiates an NGAP message (e.g., N2 Satellite Data request message 722) to target NG-RAN node 104 based on an NWDAF request. For example, the request message may specify: (1) an Event ID for the requested information (optional, this is included if the N2 UE-associated NGAP message or non-UE-associated NGAP message is not used specifically for the requested information); (2) Event Filter(s) e.g., AOI information; and Target of Event Reporting that indicates Target UE ID(s) (which may be either UE ID(s) including GPSI or SUPI, or a UE IPv4 address(es), or a UE IPv6 prefix(es), or an Internal/External Group Identifier, or an indication that any UE is targeted).

The NG-RAN node 104 provides the information to the AMF 115 based on the target UE identifier or non-UE associated information as shown in N2 Satellite Data response message 724. The AMF 115 responds to the NWDAF 116 in the Namf_EventExposure_Notify message 726 which includes available information or the information received from the NG-RAN node 104.

After collecting satellite-related data, UE-related data and UE-related analytics, the NWDAF is able to generate an analytic estimate of NTN coverage. The analytic estimate of NTN coverage may be associated with a new Analytic ID. The NWDAF 116 may generate the analytic estimate of NTN coverage based on the Analytics Filter Information requested by the service consumer. The Analytics Filter Information may provide the following information: (A) NTN coverage Type; (B) UE location; (C) Validity Period; (D) Spatial validity; (E) SUPI list; and (F) confidence information. NTN coverage Type may include Ephemeris data, an estimate of in-NTN coverage period and an estimate of out-of-NTN coverage period. The UE location indicates the reference UE location information (e.g., based on TAI list, gNB ID, cell ID, etc.) for the derived NTN coverage based on the preferred granularity of location information and the Consumer analytics request for the target UE identifier, e.g., one UE or a list of UEs. Validity Period indicates the duration the NTN coverage information is valid. Spatial validity indicates the areas where the NTN coverage analytics are applied. This information is provided if the consumer provided the AOI (e.g., a set of TAIs, NG-RAN node IDs, Cell IDs, for which the analytics information is subscribed or requested. A SUPI list which indicates the list of SUPI(s) of the UEs that may apply the same Ephemeris data. Confidence information which indicates a confidence percentage or levels for the estimation of the NTN coverage.

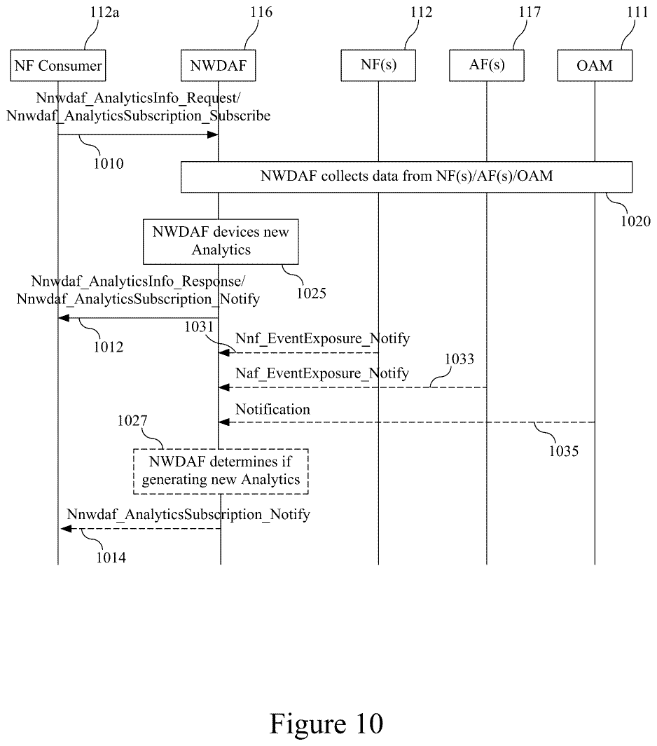

FIG. 10 is a signal diagram illustrating an enhanced NWDAF collecting input data, generating and delivering an analytic estimate of NTN coverage related to a UE. The service consumer is a network function (i.e., NF consumer 112a) which may be (A) an AF, (B) a 5G CN or OAM, (C) AMF for a delegating RAN node, or (D) AMF for delegating UE.

Initially, the 5GC NF (Consumer) 112a sends a request message(s) 1010 to the NWDAF 116 based on a one-time request or notification of analytics events. For the analytics, the request message(s) 1010 indicates the requirements for the analytics to set up the target of the Analytics reporting and the criteria to filter the information. For example, the NWDAF 116 may use the Nnwdaf_AnalyticsInfo_Request 1010 (Analytics ID, Target of Analytics Reporting, Analytics Filter Information) for one time analytics or for subscribing to the Notification of Analytics.

The request message 1010 includes the following information: (1) Analytics ID associated with NTN coverage; (2) Target of Analytics Reporting which indicates the Target UE ID(s) for which analytics information is requested (for example, entities such as specific UEs, a group of UE(s) or any UE, i.e., all UEs); (3) Analytics Filter Information corresponding to the Analytic ID of NTN coverage (which indicates the conditions to be fulfilled for reporting Analytics Information). This set of optional parameter types and values enable selecting which type of analytics information is requested.

The request message 1010 also includes: a Notification Target Address and Analytics Reporting Information. The Analytics Reporting Information may include the following parameters: (i) an analytics target period (e.g., a time interval [start . . . end], either in the past or in the future); (ii) a time when analytics information is needed (if applicable and which indicates to the NWDAF the latest time the analytics consumer expects to receive analytics data provided by the NWDAF); and (iii) a preferred granularity of location information, e.g., tracking area (TA) level or cell level.

The NWDAF collects data 1020 from OAM, NG-RAN via AMF, and/or AF as described in various embodiments above, unless the information is already available. The NWDAF derives requested analytics 1025. The NWDAF 116 provides requested Analytics Information of NTN coverage to the NF Consumer 112a, using either Nnwdaf_AnalyticsInfo_Request response or Nnwdaf_AnalyticsSubscription_Notify, as shown in message 1012, depending on the service used in message/process 1010. The Nnwdaf_AnalyticsInfo_Request response or Nnwdaf_AnalyticsSubscription_Notify message 1012 may include the following information: (1) Analytics ID for NTN coverage; (2) Analytics Information of NTN coverage based on the Target of Analytics Reporting, Analytics Filter Information, and Analytics Reporting Information; (3) a timestamp of analytics generation which allows consumers to decide until when the received information shall be used. For example, an NF may deem a received notification from NWDAF 116 for a given feedback as invalid based on this timestamp.

The NWDAF 116 receives an Nnf_EventExposure_Notify message 1031 from the NF(s) 112, a Naf_EventExposure_Notify message 1033 from the AF(s) 117 and a Notification message 1035 from the OAM 111. The NWDAF may determine to generate new Analytics 1027. If the NF 112a subscribed via message/process 1010, e.g., if AMF and/or the NWDAF generates new analytics of Analytics Information for NTN coverage, it provides the new generated analytics to the NF 112, e.g., the AMF 115.

In an embodiment, the NWDAF service consumer is the NG-RAN node 104 via the AMF 115, whereby the AMF 115 is NF Consumer 112a in FIG. 10.

For NG-RAN awareness of NTN coverage, the NG-RAN node may get rigorous NTN coverage information from NWDAF 116 via AMF 115, and the subscription to the NWDAF 116 is delegated by AMF 115. The NG-RAN 104 sets up the required mechanisms to guarantee the continuous data collection requested by NWDAF 116 via AMF 115 using UE-associated or non-UE associated NGAP message. A UE-associated NGAP message is used when the Target of Analytics Reporting indicates Target UE ID(s). A non-UE associated NGAP message is used when the Target of Analytics Reporting indicates Any UE.

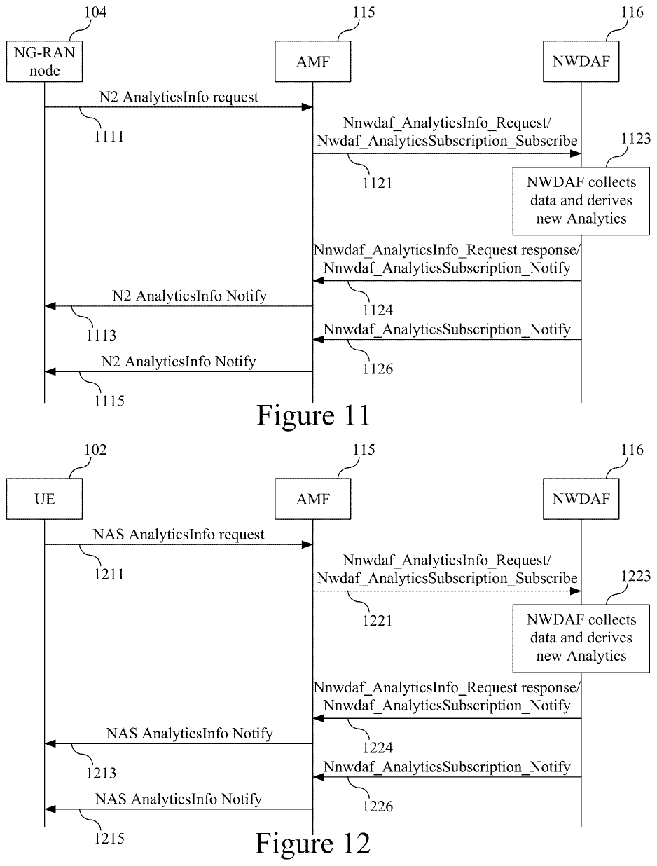

FIG. 11 is a signal diagram of a procedure performed by an NE to provide an analytical estimate of NTN coverage in an AOI to an NG-RAN node, according to an embodiment. The NG-RAN node 104 is an analytics customer of the NWDAF 116. Initially, the NG-RAN node 104 sends a N2 AnalyticsInfo Request message 1111 to the AMF 115. The N2 AnalyticsInfo Request message 1111 includes the following information: Analytics ID; a Target of Analytics Reporting; Analytics Filter Information; a Notification Target Address; and Analytics Reporting Information. The Analytics ID indicates NTN coverage (optional, this is included if the N2 UE-associated NGAP message or non-UE-associated NGAP message if not used specifically for NTN coverage). Target of Analytics Reporting indicates the Target UE ID(s) for which Analytics information is requested (entities such as specific UEs, a group of UE(s) or any UE i.e., all UEs). Analytics Filter Information corresponding to the Analytic ID of NTN coverage indicates the conditions to be fulfilled for reporting Analytics Information. This set of optional parameter types and values enables selecting the type of analytics information, Notification Target Address and Analytics Reporting Information. The Analytics Reporting Information may include the following parameters: (A) an analytics target period: time interval [start . . . end] (either in the both start time and end time in the past or in both start time and end time in the future); (B) a time when analytics information is needed (if applicable, indicating to the NWDAF the latest time the analytics consumer expects to receive analytics data provided by the NWDAF); and (C) a preferred granularity of location information, for example, TA level or cell level.

The AMF 115 then transmits a request message(s) 1121 to the NWDAF 116 based on a one-time request or notification of analytics events (this message 1121 may include the same or similar content to the message 1010). The NWDAF 116 collects data and derives requested analytics 1123 (this is performed in the same or a similar manner as described with respect to events 1020 and 1025). The NWDAF 116 provides requested Analytics Information of NTN coverage to the AMF 115 using either a Nnwdaf_AnalyticsInfo_Request response or a Nnwdaf_AnalyticsSubscription_Notify message 1124, depending on the service indicated in message/process 1121.

The AMF sends a N2 AnalyticsInfo Notify message 1113 including the Analytics Information to the NG-RAN node 104. The Notify message 1113 may include: (1) Analytics ID for NTN coverage (optional, this is included if the N2 UE-associated NGAP message or non-UE-associated NGAP message is not used specifically for NTN coverage); (2) Analytics Information of NTN coverage based on the Target of Analytics Reporting, Analytics Filter Information, and Analytics Reporting Information; and (3) a timestamp of analytics generation which allows consumers to decide until when the received information to be used. An NF may determine that a received notification from NWDAF is invalid based on the timestamp.

When appropriate, multiple Notify messages may be transmitted. In FIG. 11, the repeated Notify messages by messages 1126 and 1115. For example, when requested based on a subscription, the NWDAF 116 may transmit new information to the AMF 115 which than forwards the new information to the NG-RAN node 104.

In an embodiment, the UE 102 the NWDAF analytics service consumer, the UE receiving information via the AMF 115, which is NF Consumer as illustrated in FIG. 10. In order to become aware of NTN coverage, the UE 102 may receive NTN coverage information based on the analytic estimated NTN coverage output by NWDAF 116. In an embodiment, the subscription to the NWDAF 116 is delegated by AF 117 and the analytic estimate of the NTN coverage is delivered to the UE 102 via the user plane (e.g., the AnalyticsInfo, as generated by embodiments described herein, may be delivered using methods described in 3GPP technical specification, e.g., in 3GPP TS 23.288 clause 6.2.8.2.3).

The analytics of NTN coverage is provided to the UE 102 using a NAS message as is described with respect to FIG. 12. During a UE registration procedure (not shown in FIG. 12), the Registration request message includes an indication for NTN coverage. Based on the NTN coverage indication, the AMF 115 discovers a NWDAF instance and associates the UE 102 with the NWDAF 116.

In FIG. 12, the UE 102 sends a NAS message 1211 to the AMF 115 to request Analytics Information exposure from the NWDAF 116. In an embodiment, the NAS message 1211 is a new type of NAS message. In another embodiment, the NAS message 1211 is a UL NAS transport message. The NAS message 1211 includes the following information: an NTN coverage indication or Analytics ID indicates NTN coverage for which this UE is included if the new type of NAS message is used specifically for NTN coverage or the container is specifically for NTN coverage, or if the NAS message 1211 is a new type of NAS message, with the NTN coverage indication. The AMF 115 identifies the Analytics ID; Target of Analytics Reporting which indicates the Target UE ID(s) for which Analytics information is requested, entities such as specific UEs, a group of UE(s) or any UE (i.e., all UEs); and Analytics Filter Information corresponding to the Analytic ID of NTN coverage, which indicates the conditions to be fulfilled for reporting Analytics Information. This set of optional parameter types and values indicates the requested analytics information.

Additionally, the NAS message 1211 may include a Notification Target Address and/or Analytics Reporting Information. The Analytics Reporting Information includes the following parameters: (A) Analytics target period (e.g., a time interval [start . . . end] either both start time and end time being in the past or in both being in the future); (B) a time when analytics information is needed (if applicable) which indicates to the NWDAF the latest time the analytics consumer expects to receive analytics data provided by the NWDAF; and (C) a preferred granularity of location information: TA level or cell level.

The AMF 115 transmits a request message(s) 1221 to the NWDAF 116 based on a one-time request or notification of analytics events (this message 1221 may include the same or similar content to the message 1010). The NWDAF 116 collects data and derives requested analytics 1223 (this is performed in the same or similar manner as described with respect to events 1020 and 1025). The NWDAF 116 provides requested Analytics Information of NTN coverage to the AMF 115 using either Nnwdaf_AnalyticsInfo_Request response or Nnwdaf_AnalyticsSubscription_Notify, message 1224, depending on the service used in message/process 1221.

The AMF 115 sends a NAS AnalyticsInfo Notify message 1213 including the Analytics Information (i.e., the analytic estimated NTN coverage) to the UE 102. In an embodiment, the NAS AnalyticsInfo Notify message 1213 is a new type of NAS message. In an embodiment, the NAS AnalyticsInfo Notify message 1213 is a DL NAS transport message with a new container IE for delivery of AnalyticsInfo, and a new container type IE for the container of Analytics info. In another embodiment, the NAS AnalyticsInfo Notify message 1213 is based on UE Configuration Update Command message sent to the UE 102 (e.g., the AnalyticsInfo, as generated by embodiments described herein, which may be delivered using methods described in 3GPP technical specifications, such as, indicated in 3GPP TS 23.502 FIG. 4.2.4.2-1). In still yet another embodiment, the NAS AnalyticsInfo Notify message 1213 is a DL NAS transport message for delivering UE policy, e.g., the AnalyticsInfo, as generated by embodiments described herein, which may be delivered using methods described in 3GPP standards, such as indicated in 3GPP TS 23.502 FIG. 4.2.4.3-1. In this case, the AMF 115 notifies the PCF 113 to trigger the procedure by delivery of Analytics info as UE policy.

In an embodiment, when appropriate, the AMF 115 transmits multiple Notify messages such as messages 1226 and 1215. Transmitting multiple Notify messages may be based on a subscription or new information becoming available. The NWDAF 116 transmits the new information to the AMF 115 which then forwards the new information to the UE 102.

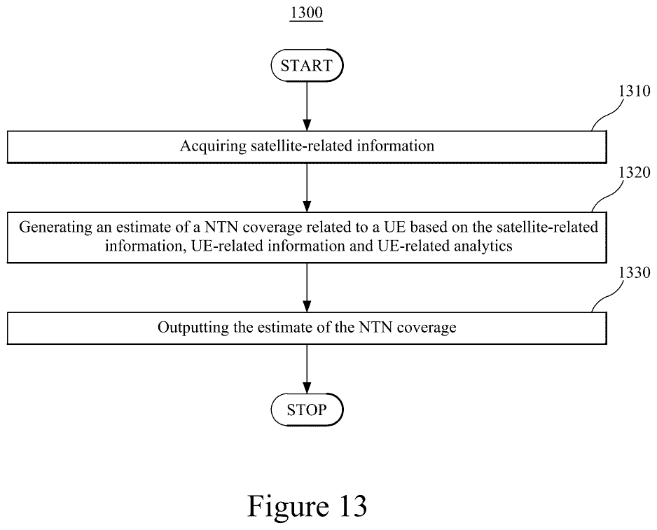

FIG. 13 is a flowchart of a method 1300 performed by an NE for providing an analytical estimate of NTN coverage, according to an embodiment. The method 1300 includes: acquiring 1310 satellite-related information. The method 1300 further includes generating 1320 an analytic estimate of an NTN coverage related to a UE based on satellite-related information, UE-related information, and UE-related analytics. The method 1300 finally includes outputting 1330 the analytic estimate of the NTN coverage.

Certain embodiments are described in this disclosure as including logic or a number of components or modules. Modules may be software modules (e.g., code stored on non-transitory machine-readable medium) or hardware modules. A hardware module is a tangible unit capable of performing certain operations and may be configured or arranged in a certain manner. A hardware module may comprise dedicated circuitry or logic that is permanently configured (e.g., as a special-purpose processor, such as a field programmable gate array, FPGA, or an application-specific integrated circuit, ASIC) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques may be provided as part of the operating system, a library used by multiple applications, a particular software application, etc. The software may be executed by one or more general-purpose processors or one or more special-purpose processors.

1-16. (canceled)

17. A communication method performed by a network entity, NE, of a core network the method comprising:
generating an analytic estimate of a non-terrestrial network, NTN, coverage related to a user equipment, UE, the generating of the analytic estimate of the NTN coverage including estimating an in-NTN coverage period and/or an out-of-NTN coverage period for an area of interest, and being based on:
satellite-related information,
UE-related information acquired from at least one of: the UE, a base station serving the UE, or a network function of the core network, and
UE-related analytics generated by a network data analytic function, NWDAF, of the core network as defined in 3GPP technical specifications; and
outputting the analytic estimate of the NTN coverage.

18. The method of claim 17, wherein the NE executes the NWDAF that generates the UE-related analytics.

19. The method of claim 17, wherein the UE-related analytics comprise one or more of: analytics of a UE mobility or analytics of a UE communication.

20. The method of claim 17, wherein the generating of the analytic estimate of the NTN coverage further includes associating at least one of: a validity period, a confidence measure, or a list of one or more subscribers to which the analytic estimate of the NTN coverage is pertinent.

21. The method of any of claims 17, further comprising:
acquiring the satellite-related information from at least one of
an operations, administration and maintenance function, OAM,
a Next Generation Radio Access Network, NG-RAN, node via an Access and Mobility Management function, AMF, or
an application function, AF,
wherein the OAM, the AMF, and the AF are defined in 3GPP technical specifications.

22. The method of claim 21, wherein the acquiring of the satellite-related information comprises:
performing an OAM subscribing procedure to enable the acquiring of the satellite-related information from the OAM.

23. The method of claim 21, wherein the acquiring of the satellite-related information comprises:
performing an AMF subscribing procedure to enable the acquiring of the satellite-related information from the AMF.

24. The method of claim 21, wherein the acquiring of the satellite-related information comprises:
performing an AF subscribing procedure to enable the acquiring of the satellite-related information from the AF.

25. The method of claim 17, further comprising:
subscribing, via a Unified Data Management function, at a network function to collect UE-related information.

26. The method of claim 17, wherein the outputting of the analytic estimate of the NTN coverage comprises at least one of:
upon receiving an event exposure notification, providing the analytic estimate of the NTN coverage to the network function;
providing the analytic estimate of the NTN coverage to an Access and Mobility Management function, AMF, as defined in 3GPP technical specifications, to be delivered to an information-requesting Radio Access Network, RAN, node; or
providing the analytic estimate of the NTN coverage to an Access and Mobility Management function, AMF, as defined in 3GPP technical specifications, to be delivered to the UE.

27. The method of claim 26, wherein the providing of the analytic estimate of the NTN coverage to the AMF is triggered by a non-access stratum, NAS, request message transmitted by the UE via the AMF.

28. The method of claim 17, wherein the outputting of the analytic estimate of the NTN coverage occurs periodically.

29. A network entity (NE) of a core network, the NE comprising:
a transceiver configured to communicate with a UE via a satellite; and
a processor controlling the transceiver and configured
to generate an analytic estimate of a non-terrestrial network, NTN, coverage related to a user equipment, UE, by estimating an in-NTN coverage period and/or an out-of-NTN coverage period for an area of interest, based on:
satellite-related information,
UE-related information acquired from at least one of: the UE, a base station serving the UE, or a network function of the core network, and
UE-related analytics generated by a network data analytic function, NWDAF, of the core network as defined in 3GPP technical specifications; and
to output the analytic estimate of the NTN coverage using the transceiver.

30. The NE of claim 29, wherein the processor outputs the analytic estimate of the NTN coverage periodically.

31. The NE of claim 29, wherein the UE-related analytics comprise one or more of: analytics of a UE mobility or analytics of a UE communication.

32. A communication method performed by a user equipment, UE, the method comprising:
transmitting, to a network entity, NE, of a core network, a non-access stratum, NAS, message to request analytics information, the NAS message indicating a non-terrestrial network, NTN, coverage; and
receiving, from the NE, a NAS message conveying the analytics information including an analytic estimate of the NTN coverage related to the UE and based on
satellite-related information,
UE-related information acquired from at least one of: the UE, a base station serving the UE, or a network function of the core network, and
UE-related analytics generated by a network data analytic function, NWDAF, of the core network as defined in 3GPP technical specifications.

33. The communication method of claim 32, wherein the NE is an Access and Mobility Management function, AMF, as defined in 3GPP technical specifications.

34. The communication method of claim 32, wherein the receiving of the NAS message including the analytics information occurs periodically.

35. The communication method of claim 32, wherein the analytic estimate of the NTN coverage includes an in-NTN coverage period and/or an out-of-NTN coverage period for an area of interest.

36. A user equipment (UE), comprising:
a transceiver configured to communicate with a network entity (NE) of a core network via a non-terrestrial network, NTN; and
a processor controlling the transceiver
to transmit, to the NE, a non-access stratum, NAS, message to request analytics information, the NAS message indicating an NTN coverage; and
receiving, from the NE, a NAS message conveying the analytics information including an analytic estimate of the NTN coverage related to the UE and based on
satellite-related information,
UE-related information acquired from at least one of: the UE, a base station serving the UE, or a network function of the core network, and
UE-related analytics generated by a network data analytic function, NWDAF, of the core network as defined in 3GPP technical specifications.
